(19) United States
(12) Patent Application Publication
(10) Pub. No.: US 2007/0151158 A1
(43) Pub. Date: Jul. 5, 2007

(54) Window lift mechanism

(76) Inventor: Paul J. Fenelon, Nashville, TN (US)

Correspondence Address: HARNESS, DICKEY & PIERCE, P.L.C., P.O. BOX 828, BLOOMFIELD HILLS, MI, 48303, US

(21) Appl. No.: 11/324,365

(22) Filed: Jan. 3, 2006

(51) Int. Cl. E05F 15/16

(52) U.S. Cl. 49/349

(57) ABSTRACT

A window lift mechanism includes a worm/worm gear transmission with an improved transmission housing having a worm gear shaft formed in-situ as well as a pinion gear formed as a unitary member with the worm gear in order to reduce the number of components and improve the assembly process.

### FIELD OF THE INVENTION

The present invention generally relates to an apparatus for moving a window into an open or closed position. In particular, the present invention relates to a mechanism for use with an automobile window, wherein the mechanism utilizes an improved dual rack and pinion assembly and method of manufacturing.

### BACKGROUND AND SUMMARY OF THE INVENTION

Modern automobiles typically include a window lift assembly for raising and lowering windows in the door of the vehicle. A common type of window lift assembly incorporates a “scissor mechanism” or a drum and cable mechanism. A scissor-type system utilizes a series of linkages in a scissor configuration such that as the bottom linkages move apart, the top linkages do as well, resulting in a scissor-like motion. The window is fastened to a bracket connected to a linkage. A motor and gearset drives the scissor mechanism in power operated window mechanisms.

The scissor-type and drum and cable mechanisms are typically mechanically inefficient, prohibiting the use of light-weight materials and requiring the use of relatively large motors to drive the system. The large motors necessarily require increased space and electrical power and also increase the weight of the system. In a scissor-type or drum and cable system it is also necessary, in order to provide the required torque transfer efficiency and acceptable up and down times (3-4 seconds), to have a small diameter pinion gear, typically 0.5 to 0.75 inches, and relatively large worm gear, typically 1.8 to 2.5 inches in diameter, with gear ratios of 9 to 16 and 60 to 90, respectively. This results in excessive worm gear speed in the range of 3000 to 4000 RPM which causes excessive worm gear tooth shock and armature noise. The combination of high torque, typically 80 to 125 inch-pounds at stall, and shock due to high worm speeds mandates that either expensive multiple gears and/or single worm gears with integral shock absorbers be utilized.

Further, the scissor-type mechanism does not take into account the manufacturing deviations in the door, specifically with the window frame and mounting points, and deviations in the manufacture of the scissor-type mechanism. Deviations in the door and scissor-type mechanism result in larger than necessary forces being applied to the window when it cycles up and down. The larger force on the window causes undesirable noise in the passenger cabin.

Recently, rack and pinion and dual rack and pinion-type drive systems have been developed and have proven to be more efficient than alternate mechanisms. The improved efficiency provides for a smaller motor (less powerful) to drive a closure than conventional scissor-type and/cable units.

Typical drive systems include a metal worm which drives a thermoplastic worm gear. The transmission housing is typically made of reinforced engineered thermoplastic and/or thermoset composites. Because the metal worm rotates at high speed, typically 4000 rpm with stall torques in the range of 8 to 12 N-m, it is necessary that the worm be coupled to a shock absorber (cushion) so that during deceleration/stopping, the stall torque is spread over a number of gear teeth. Because these closures always drive in a closed loop, stopping always occurs at the same place and, hence, the same worm gear tooth. The shock absorber provides for spreading of the stopping force over a number of teeth, and exponentially improves the worm gear's life cycle.

A typical worm gear motor transmission for a rack and pinion system consists of (i) a transmission housing; (ii) a metal worm with guides and bearings integral with the motor armature shaft; (iii) a thermoplastic worm gear; (iv) an elastomeric shock absorber; (v) a thermoplastic or metal drive coupler; (vi) an over-molded worm gear metal shaft; (vii) a seal; (viii) a cover plate; and (ix) a drive pinion gear.

Historically, the overmolded worm gear shaft manufactured from approximately 0.5 inches diameter steel is utilized to provide sufficient rigidity to maintain worm-to-worm gear interaction (i.e., center-to-center distance) while occupying minimum space. In current worm gear motor transmissions, space is required so that an efficient shock absorber drive coupler mechanism can be incorporated into the space and ensure a useful worm gear life.

According to the present disclosure, the improved efficiency of rack and pinion regulator systems has been discovered to allow for the total elimination and/or reduction of the worm gear shock absorber drive coupler mechanism for closures requiring stall torques less than 8 N-m and stall torques between 8 to 10 N-m, respectively. The elimination/reduction of the shock absorber drive coupler mechanism provides for sufficient extra space so that the diameter of the worm gear shaft may be increased and an in-situ thermoplastic/thermoset shaft can replace the expensive over-molded metal shaft. By eliminating the shock absorber and providing for an in-situ molded shaft integrally formed with the transmission housing, the present disclosure provides numerous beneficial attributes including reducing the number of total components, eliminating critical precision related assembly steps, and reducing the overall number of assembly steps. For rack and pinion regulator systems requiring a stall torque of greater than 10 N-m, an in-situ formed thermoplastic/thermoset worm gear support shaft can be utilized with a shock absorber, if the material is of sufficient strength to support the worm gear.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front view of a window lift mechanism according to the principles of the present invention;

FIG. 2 is a rear view of the window lift mechanism shown in FIG. 1;

FIG. 3 is a partially exploded perspective view of a motor and transmission mechanism used in the window lift mechanism shown in FIGS. 1 and 2.

FIG. 4 is a partially exploded perspective view of an alternative motor and transmission mechanism used in the window lift mechanism shown in FIGS. 1 and 2.

### DETAILED DESCRIPTION OF THE PREFERRED EMBODIMENTS

The following description of the preferred embodiment(s) is merely exemplary in nature and is in no way intended to limit the invention, its application, or uses.

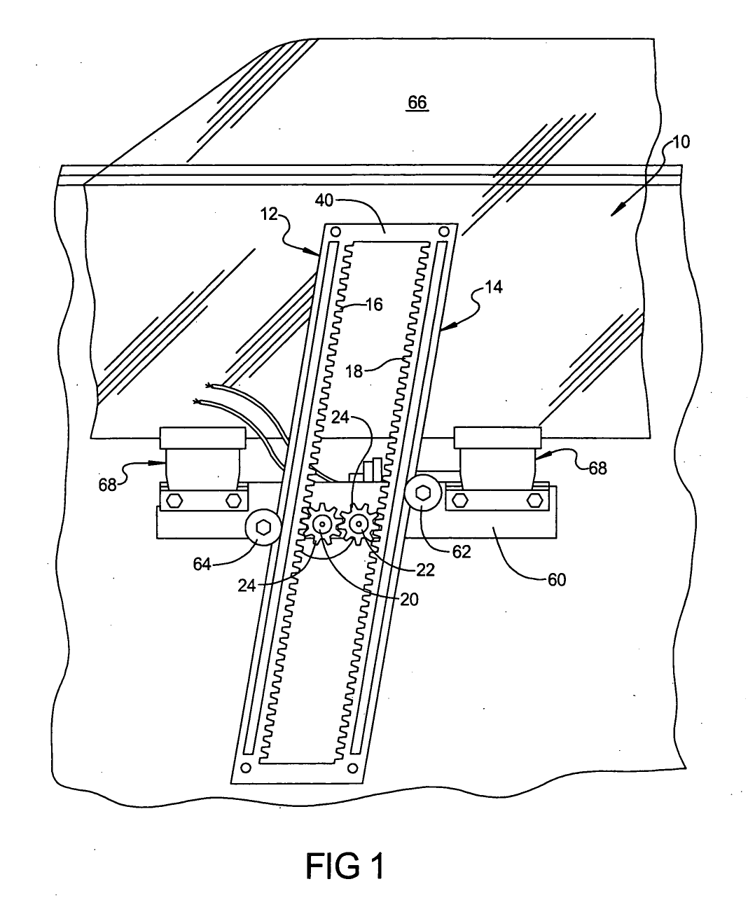

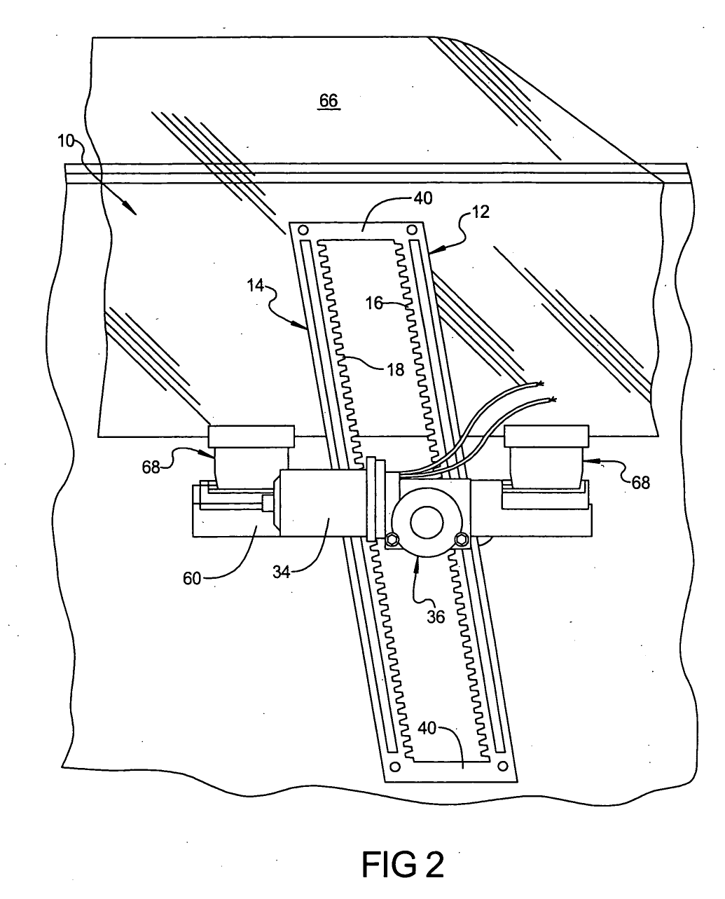

With reference to FIGS. 1 and 2, a window lift mechanism 10, according to the principles of the present invention, will now be described. The window lift mechanism includes first and second racks 12, 14, each including a row of teeth 16, 18, respectively, which face toward one another. First and second pinion gears 20, 22 are also provided which include teeth 24 in engagement with the teeth 16, 18 on the first and second racks 12, 14. The first and second pinion gears 20, 22 are also in meshing engagement with one another. Specifically, the first and second racks 16, 18 are positioned closely together such that the spacing between the first and second racks 16, 18 is the minimum necessary to accommodate the first and second pinion gears 20, 22.

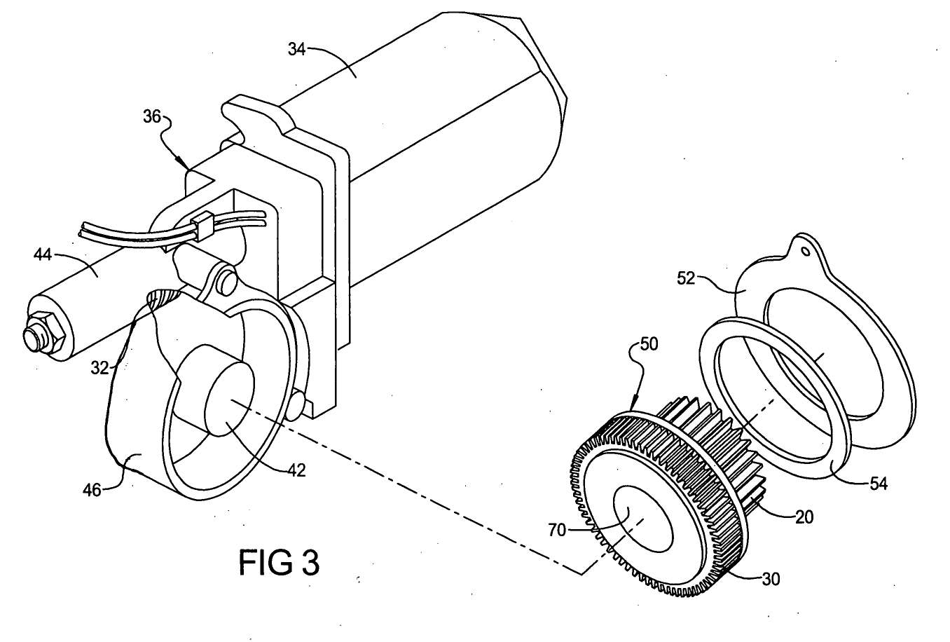

The pinion gear 20 is connected to a worm gear 30 as illustrated in FIG. 3. Worm gear 30 is in meshing engagement with a worm 32 which is connected to the motor 34. The worm 32 and worm gear 30 are supported within a transmission housing 36.

The first and second racks 12, 14 are joined by cross-members 40 with the first rack 12, second rack 14, and cross members 40 being molded as a single piece to form an integral, unitary member. It should be understood that the cross members 40 can be provided at each end, as shown, and can also be provided intermediately.

The transmission housing 36 includes an elongated portion 44 for receiving a worm 32 therein. A worm gear chamber portion 46 is formed adjacent to the elongated portion 44 and includes an integrally formed shaft portion 42 which supports the worm gear 30 in meshing engagement with worm 32. The shaft portion 42 is formed in-situ and has a diameter which is determined based upon the material characteristics so as to be sufficiently rigid to provide a rigid mounting for the worm gear 30. The worm gear 30 is formed having a larger diameter than the pinion gear 20 and includes a flat surface 50 defining a bearing surface against which a cover or retainer plate 52 is mounted to the housing in order to secure the worm gear 30 within the worm gear chamber portion 46. A seal 54 is provided between the cover 52 and the housing portion 46.

The motor and transmission housing 36 are mounted to a support bracket as illustrated in FIGS. 1 and 2. The support bracket 60 is provided with guide members such as rollers 62, 64 that engage the racks 12, 14. Alternatively, the guide members can be integrally formed with support bracket 60. A window 66 is mounted to the support bracket 60 by mounting members 68. The worm gear 30 and pinion gear 20 are integrally formed as a unitary member, and include an aperture 70 therethrough which rotates on spindle portion 42 of housing 36.

As compared to typical worm gear motor transmissions which include approximately nine components, the present design reduces the number of components from nine to five. In particular, the new components include (i) the transmission housing with “in-situ” molded shaft 42; (ii) metal worm 32 formed integral with the armature shaft of motor 34; (iii) thermoplastic worm gear 30 molded as one piece with pinion drive gear 20; (iv) seal 54; and (v) cover plate 52. The present design also eliminates a critical quality related assembly step by eliminating the use of a metal shaft as the worm gear axle. The previously used metal shaft which was molded into the transmission housing was costly and time consuming in that it demanded care so that the center-to-center distance between the worm and shaft was maintained. When replaced with an in-situ shaft according to the present disclosure, the cost is reduced, molding cycle time is improved, and the critical placement of the metal shaft prior to over-molding is eliminated. In addition, according to the present disclosure, a number of the assembly steps are eliminated. Historically, assembly comprised of loading the metal shaft for the over-molding operation of the transmission housing, loading of the worm gear, loading of the shock absorber, loading of the drive coupler, and loading of the pinion gear. With the present invention, the five assembly steps above are replaced by one, namely loading of a single piece molded worm gear and pinion gear so that four assembly steps are eliminated.

To function properly, automobile widows must have a high level of rotational stability (i.e., minimal to zero back and forth movement under load), vertical stability (i.e., minimal to zero up and down movement under load), and must track consistently so that fluid operation and closure/side seals are maintained. Typically, rotational stability is achieved by adding guide tracks at the window edge below the glass belt line. Vertical stability is achieved by rigidifying the total system and removing any and all slack from the moving components. Tracking/sealing is achieved by selective use of soft guides above the glass belt line and in the door header.

A worm gear shock absorber functions by allowing relative movement between worm, worm gear, and pinion gear under load. Removal of the shock absorber, according to the present disclosure, eliminates, or greatly reduces this movement. Hence, under rotational load, the allowed movement of a shock absorber-free rack and pinion regulator is greatly reduced. This translates to reduced rotational movement of an attached window and provides for the elimination or reduction (sealing back) of window guides below the belt line. Similarly, removal of the worm gear shock absorber greatly enhances vertical stability of rack and pinion regulators under load. This enhancement facilitates improved repetitive cyclic performance of the system and is synergistic when incorporated with “Smart” regulators wherein rapid up and down and instantaneous reverse under load to avoid finger and/or head jamming are built into the motor dynamics. Smart regulators utilize smart motors wherein Hall effect sensors are incorporated into the motor so that current, velocity and/or position are continuously monitored. Slack-free full repetitive performance is critical to life-cycle functioning of Smart regulators.

Table 1 below illustrates the improved vertical stability of rack and pinion regulators over a conventional single rail cable unit as measured. For example, full glass down position after life cycle testing (26,000 cycles) was off by 1.8 millimeter for a single cable driven window versus 0.2 millimeter for a rack and pinion regulator with a shock absorber. Based on the data listed in Table 1, it is anticipated that rack and pinion regulators without shock absorbers will be off by considerably less than 0.2 millimeter, and will provide for best-in-class Smart regulators.

TABLE 1

Vertical
Stability
(Millimeters
of Movement)
Load (pounds)

| Regulator Type | (100) | (200) |
|---|---|---|
| Single Rail Cable | 7-9 | 16-20 |
| Rack & Pinion with Shock Absorber | 3-5 | 4-8 |
| Rack & Pinion without Shock Absorber | 1-2 | 2-4 |

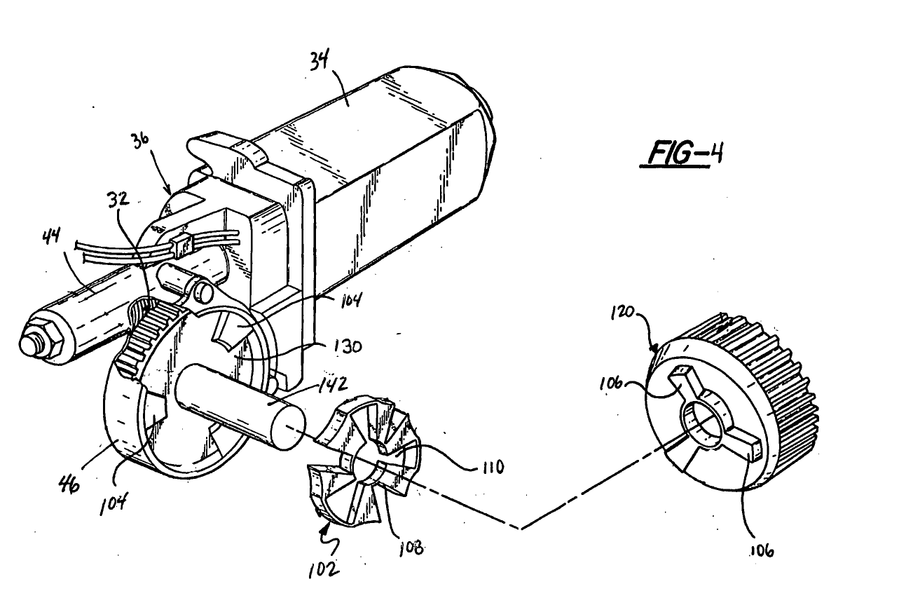

It should be understood that for drive systems having stall torques greater than 8 N-m, the use of an in-situ formed shaft 142, as shown in FIG. 4, for supporting the worm gear 130 can be utilized with a shock absorber 102 so long as the material strength and size of the in-situ formed shaft 142 are sufficient to withstand the related forces. The shock absorber 102 is disposed between the worm gear 130, which is provided with tabs 104 and the pinion gear 120, which is also provided with tabs 106. Tabs 04 and 106 each engage outwardly facing recesses 108 and inwardly facing recesses 110, respectively of the shock absorber 102, as is known in the art.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A drive assembly, comprising:
a motor drivingly attached to a worm;
a plastic transmission housing mounted to said motor, said transmission housing including a first chamber for receiving said worm and a second chamber adjacent said first chamber, said second chamber including an integrally formed plastic shaft extending therefrom; and
a worm gear disposed in said second chamber and rotatably mounted on said plastic shaft.

2. The drive assembly according to claim 1, wherein said worm gear has a pinion gear integrally formed therewith as a unitary member.

3. The drive assembly according to claim 2, wherein said worm gear and said pinion gear are formed from plastic.

4. The drive assembly according to claim 2, further comprising a cover member attached to said second chamber for retaining said worm gear in said second chamber, said cover member including an opening there through for receiving said pinion gear.

5. The drive assembly according to claim 1, wherein said motor has a stall torque of 8 N-m or less.

6. The drive assembly according to claim 1, wherein said motor has a stall torque of 8 N-m or more.

7. A window lift mechanism, comprising:
a closure member;
at least one elongated rack;
a support bracket attached to said closure member and movable along said rack;
a pinion gear in driving engagement with said rack;
a plastic transmission housing including a first chamber and a second chamber adjacent said first chamber, said second chamber including an integrally formed plastic shaft extending therefrom;
a motor drivingly attached to a worm, said worm being disposed in said first chamber;
a worm gear disposed in said second chamber and rotatably mounted on said plastic shaft, said worm gear engaging said worm.

8. The window lift mechanism according to claim 7, wherein said worm gear and said pinion gear are integrally formed as a unitary member.

9. The window lift mechanism according to claim 7, wherein said worm gear and said pinion gear are formed from plastic.

10. The window lift mechanism according to claim 8, further comprising a cover member attached to said second chamber for retaining said worm gear in said second chamber, said cover member including an opening there through for receiving said pinion gear.

11. The window lift mechanism according to claim 7, wherein said motor has a stall torque of 8 N-m or less.

12. The window lift mechanism according to claim 7 wherein said motor has a stall torque of 8 N-m or more.
